(19) United States
(12) Patent Application Publication
(10) Pub. No.: US 2015/0210400 A1
(43) Pub. Date: Jul. 30, 2015

(54) COMPONENT OF A NACELLE HAVING IMPROVED FROST PROTECTION

(71) Applicant: AIRCELLE, Gonfreville L'Orcher (FR)

(72) Inventors: Patrick Gonidec, Bretx (FR); Bertrand Desjoyeaux, Sainte Adresse (FR); Caroline Coat-Lenzotti, Toussus Le Noble (FR)

(21) Appl. No.: 14/678,200

(22) Filed: Apr. 3, 2015

Related U.S. Application Data
(63) Continuation of application No. PCT/FR2013/052395, filed on Oct. 8, 2013.

(30) Foreign Application Priority Data
Oct. 9, 2012 (FR) 1259599

(51) Int. Cl. B64D 15/16; F01D 25/00; B64D 29/06

(52) U.S. Cl. CPC B64D 15/16; B64D 29/06; F01D 25/005

(57) ABSTRACT

The present disclosure concerns a component of an aircraft nacelle formed from at least one composite structure and one heating element. The nacelle includes frost protector, and the composite structure has a matrix reinforced by at least a material of which the heat conductivity at ambient temperature that is greater than or equal to 800 W·m⁻¹·K⁻¹, so as to provide transverse heat conductivity within the nacelle.

### CROSS-REFERENCE TO RELATED APPLICATIONS

This application is a continuation of International Application No. PCT/FR2013/052395, filed on Oct. 8, 2013, which claims the benefit of FR 12/59599, filed on Oct. 9, 2012. The disclosures of the above applications are incorporated herein by reference.

### FIELD

The present disclosure relates to an element constituting an aircraft nacelle formed of a composite structure associated with a heating element and, more particularly but not exclusively, with a leading edge structure in particular for aircraft engine nacelle air inlet.

### BACKGROUND

The statements in this section merely provide background information related to the present disclosure and may not constitute prior art.

As it is known per se, an aircraft engine nacelle forms the fairing of this engine and the functions thereof are multiple: this nacelle in particular includes in its upstream part a part usually called “air inlet”, which has a generally annular shape, and of which the role is in particular to channel the outside air in the direction of the engine.

As is visible on FIG. 1 attached hereto, it has been represented in a schematic manner a section of such an air inlet in longitudinal section.

This nacelle part includes, in its upstream area, a leading edge structure 1 comprising, on the one hand a leading edge 2 strictly speaking usually called “air inlet lip”, and on the other hand a first internal wall 3 defining a compartment 5 in which are disposed frost protection means 6, namely any means allowing to provide the anti-icing and/or the defrosting of the lip.

It is here reminded that the defrosting is getting rid of the already formed ice, and that the anti-icing is preventing any formation of ice.

The air inlet lip 2 is fixed by riveting to the downstream part 7 of the air inlet, this downstream part including on the external face thereof a protective cowl 9 and on the internal face thereof acoustic absorption means 11 usually called “acoustic shroud”; this downstream part 7 of the air inlet defines a sort of chamber closed by a second wall 13.

As a general rule, the assembly of these pieces is formed in metallic alloys, typically aluminum based for the air inlet lip 2 and the protective cowl 9, and titanium based for the two walls 3 and 13. The cowl 9 may also be made in composite material.

Such a classic air inlet has a certain number of drawbacks: the weigh thereof is relatively high, the construction thereof requires many assembling operations, and the presence of many rivets affects the aerodynamic qualities thereof.

In order to get rid of these drawbacks, a natural evolution would be to replace the metallic materials by composite materials.

Many researches have been conducted with a view to using composite materials, particularly for the leading edge structure 1.

However, these researches have up until now come up against the issue of thermal behavior of the composite materials and to the consequences on the efficiency of the defrosting and anti-icing systems set up in the air inlet lip.

The heat conduction of the composite materials is lower than that of the metallic materials, and in particular aluminum.

It becomes insufficient for allowing efficient protection against frost when the hot defrosting source is located within the air inlet lip or on the inner surface thereof.

It is difficult to reconcile the relative requirements pertaining to the defrosting and/or anti-icing of the air inlet lip 2 and those pertaining to the mechanical behavior of said lip 2 for a lip made in “classic” composite materials.

In fact, the required temperature cannot be reached on the outer skin of the lip for providing efficient anti-icing and/or defrosting, without thermally damaging the composite material by exceeding its glass transition temperature in various points.

The modification of the dimensions of the composite material, and more particularly a reduction in the thickness of the composite material, does not allow resolving this issue.

Moreover, such a modification renders the leading edge structure unfit for supporting the other environmental constraints inherent to the use thereof.

In fact, such a modification leads to a decrease in the resistance of the air inlet lip with respect to mechanical constraints, of static resistance type and/or resistance to the impact of tools, birds or hail.

Moreover, the air inlet lip is subjected to a violent air current which causes a serious risk of erosion on a composite material.

A considered solution for remedying to the main aforementioned drawbacks proposes a leading edge formed of at least one multi-axial composite structure superimposed on the heating element intended for the defrosting and/or the anti-icing.

It is meant by multi-axial composite structure, a composite comprising fibers in the three directions, in space, of which reinforcing fibers crossing it in its thickness, allowing to connect the layers of composites together.

Such a structure slightly improves the thermal conductivity but considerably complicates the method of realization.

Furthermore, in order to sufficiently increase, the transverse thermal conductivity, for, for example, a composite with an epoxy matrix, 15 to 20% of fibers would be required, which is, technically speaking very difficult, and highly penalizes the mechanical features in the plane of the lip.

### SUMMARY

The present disclosure provides a composite leading edge structure which allows efficient anti-icing or defrosting, particularly in the case of electrical protective means against frost particularly if these heating elements are mounted on the inner face of the air inlet lip.

As a leading edge structure is provided to offer a certain resistance against the possible impacts (for example hail) while continuing to provide an efficient defrosting and/or anti-icing function, it is necessary to improve the conductivity of the material constituting this element.

The present disclosure also provides a leading edge structure with enhanced heat conduction in the thickness of the structure allowing to reduce the temperature differences between the inner and outer skins of the leading edge, to increase the heat efficiency of the lip system—protective means against frost, and to reduce the heat increase response time.

It is also advantageous to be able to adapt the heat conduction of the leading edge structure on its profile, that is to say the evolution thereof along the longitudinal axis of the nacelle and radially. More particularly, it is to propose a leading edge structure in which the various aspects of heat dissipation are managed and, in particular, the direction of this heat dissipation in the leading edge structure, according to the profile of the leading edge and according to the particular dimensions involved.

Another form of the present disclosure is to propose a composite leading edge structure with enhanced heat conduction while providing an improved cohesion of the reinforcement within the matrix.

This form of the present disclosure is reached with an element constituting an aircraft nacelle formed of at least one composite structure and one heating element and comprising frost protection means characterized in that the composite structure has a matrix reinforced by at least one material of which the thermal conductivity at room temperature is greater than or equal to 800 W·m⁻¹·K⁻¹ in such a manner as to provide a transverse thermal conductivity within the nacelle element.

Such a composite imparts the element constituting the nacelle which may be a leading edge structure with good heat properties considering the presence of the doping material in the thickness of the composite structure, while providing a good resistance with respect to the different impacts and the erosion which it may have to be subjected to while not hindering the cohesion of the fibers of the composite material within the matrix.

The presence of the doping material in an adequate manner within the matrix causes an increased thermal conductivity in particular in the direction of the thickness of the composite structure (thicknesses and progressing conductivity or not according to the sought purpose), allowing to be able to reach a suitable temperature for an efficient defrosting and/or anti-icing on the outer skin of the leading edge while maintaining the resin of the composite structure below its glass transition temperature in every point and at all moments.

This increased conductivity also improves the properties of the resin of the composite structure during curing by homogenizing more rapidly the distribution of temperature in the material during this operation while reducing the heat gradients and hence the inner constraints during cooling of the composite just after curing.

According to other optional features of the leading edge structure according to the present disclosure:
the composite structure has a matrix reinforced by at least a diamond powder in such a manner as to provide a transverse thermal conductivity within the nacelle element;
the composite structure has a matrix reinforced by at least nanoparticles or nanotubes so as to provide a transverse thermal conductivity within the nacelle element;
the rate a of material doping the matrix of the composite structure is located between 1 and 50%;
the rate a of material doping the matrix of the composite structure is located between 50% and 90%;
the composite structure is configured such that the material doping of the matrix of said structure progresses in the thickness of said structure;
the material doping of the matrix of said structure is higher in outer plies of the composite structure forming the outer face of the element;
only the matrix of some plies of the composite structure is selectively material doped;
the composite structure is configured in such a manner that the granulometry of the material doping the matrix of said structure progresses in the thickness of said structure;
the composite structure has a density of fibers variable in the thickness of said structure;
the element further comprises, an assembling material between the composite structure and the heating element, this assembling material being reinforced by at least one material of which the thermal conductivity at room temperature is greater than or equal to 800 W·m⁻¹·K⁻¹ in such a manner as to provide a transverse thermal conductivity within the nacelle element;
the element further comprises, a heat insulator laid in the heating element or covered by the heating element or separated from the heating element by a structure of composite plies.

The present disclosure also relates to a leading edge structure in particular for aircraft nacelle air inlet, comprising a leading edge and an internal wall defining a longitudinal compartment inside this leading edge housing defrosting, and/or anti-icing means, the leading edge being formed of at least one composite structure and one heating element in which the leading edge is formed of an element such as aforementioned.

The present disclosure also relates to an air inlet, characterized in that it comprises a leading edge structure in accordance with the preceding.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 schematically represents an air inlet section in longitudinal section of the prior art (see preamble of the present description); and

FIGS. 2 to 5 represent cross-sectional views of different forms of an air inlet leading edge structure according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

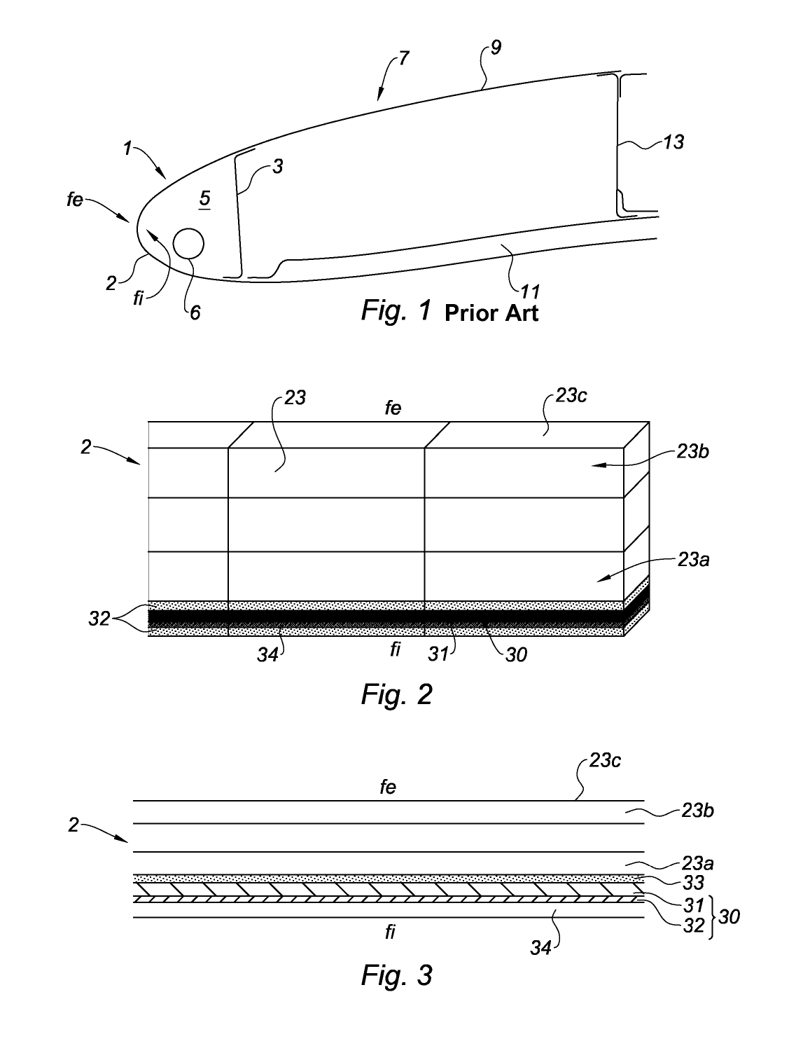

In reference to FIG. 1, a leading edge structure 1 particularly intended to be integrated to an aircraft engine nacelle air inlet typically comprises, as described beforehand in the prior art, a leading edge 2 and an internal longitudinal wall 3 defining a compartment intended to particularly accommodate, frost protection means 6 of defrosting and/or anti-icing means type.

The frost protection means may be of any type.

More particularly, these means may be pneumatic, electric defrosting and/or anti-icing means set up in the leading edge 2 or inner defrosting and/or anti-icing means of any other type.

It is further defined as illustrated on FIG. 1, the outer face fe of the leading edge structure 2 such as the external face, exposed to the outside frosting gas and the inner face fi of the leading edge structure 2 such as the internal face of the structure delimiting the compartment.

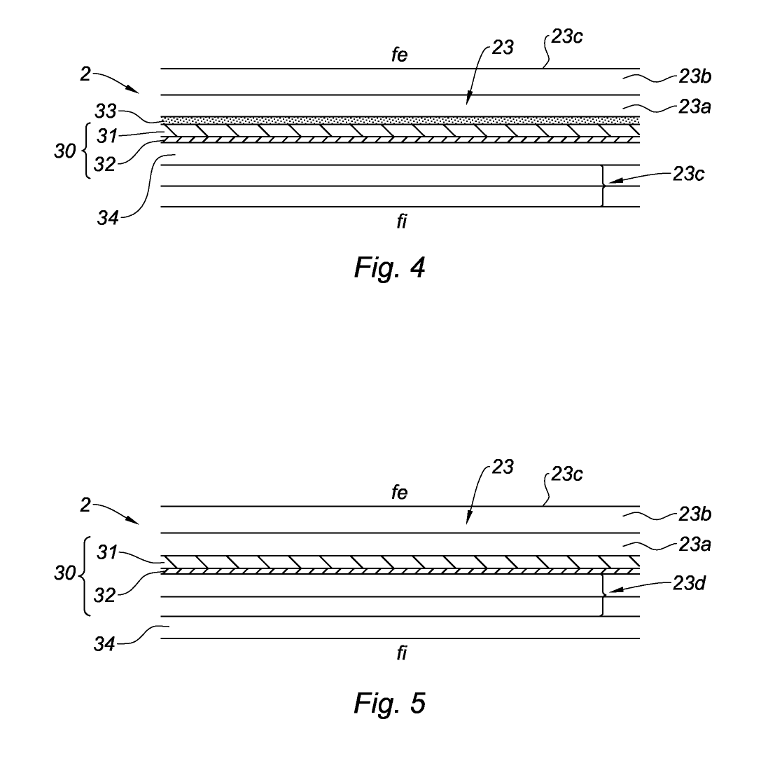

Now in reference to FIG. 2, it has been represented a first particular form of a leading edge structure 2 of air inlet lip according to the present disclosure.

In a variant, this leading edge 2 may be structural.

As explained beforehand, this means that the leading edge 2 has a function of structure, as well as an aerodynamic function.

The forces are also further, absorbed by the correctly sized internal wall 3.

In a variant, the leading edge 2 has a variable thickness along the profile thereof, and in particular, for example, a more important thickness at the strong curvatures and less important at its ends.

Furthermore, the leading edge 2 is formed by a stacking of particular layers.

In the form illustrated on FIG. 2, the defrosting and/or anti-icing means are electric.

This leading edge 2 comprises at least one structure in composites 23 superimposed on a surface heating device 30.

This heating device 30 is at least constituted of an electrically conductive layer 31 conveniently insulated electrically by an electric insulator 32.

In a non-limiting variant, the electric insulator 32 is formed for example, by two layers 32 of elastomeric or composite materials placed on either side of the electrically conductive layer 31.

The electrically conductive layer 31 or core 31 integrated to the air inlet lip 2 is designed like a heating element intended to provide calories to the lip structure 2 and contribute in eliminating the ice or keep the outer surface fe of the lip 2 in contact with the frosting gas frost free.

It may comprise, in non-limiting variants, a resistive electric circuit or a heating carpet.

In addition, it may also optionally, be integrated a layer of an adhesive material 33 at the interface of the composite structure 23 and the heating structure 30, such as illustrated on FIGS. 2 and 3.

Furthermore, it may also optionally be integrated, a layer of thermally insulated material 34 to the air inlet lip structure 2.

In the form of FIG. 2, the heat insulator 34 is laid within the heating device 30 and, more particularly, placed in contact with the electrically conductive layer 31.

A variant is illustrated on FIG. 3. This variant is identical to FIG. 2 apart from the following differences.

The heat insulator 34 is covered by the heating device 30 and, more particularly, placed in contact with an electric insulating layer 32.

In addition, the layer of an adhesive material 33 is set up at the interface of the composite structure 23 and of the electrically conductive layer 31 of the heating structure 30, an electric insulating layer 32 having been removed.

In these two forms illustrated on FIGS. 2 and 3, the assembly heat insulator 34—heating device 30 is located on the side of the inner face fi of the air inlet lip 2 and forms the inner skin of the air inlet lip 2, the surface exposed to the outside frosting gas found against the free face 23c of the composite structure 23.

In variants, the heating structure 30 may be integrated that is to say, laid in the thickness of the composite structure 23.

One of these variants is illustrated on FIG. 4.

This variant is identical to FIG. 3 apart from the following differences.

The heating structure 30 and the heat insulator 34 are set up in the core of a composite structure by being covered with a composite structure 23 and 23d of one or several layers, respectively on the side of the outer face fe and on the side of the inner face fi.

Another variant is illustrated on FIG. 5.

This variant is identical to FIG. 4 apart from the following differences.

Only the heating structure 30 is set up in the core of a composite structure by being covered with a composite structure 23 of one or several layers, respectively on the side of the outer face fe and on the side of the inner face fi.

As for the heat insulator 34, it forms the inner skin of the air inlet lip 2, the surface exposed to the outer frosting gas found against the free face 23c of the composite structure 23.

It is worth noting that the adhesive layer 33 between the acoustic structure 23 and the heating structure 30 has been removed in this form.

Furthermore, it may be used for the heat insulating 34 and electric insulating 32 layers in particular materials compatible with a composite structure.

Thus, an electric heating structure may be made by a metallic resistive circuit encapsulated between two layers of insulating fibers such as glass fibers or Kevlar®, the assembly being itself laid in a thermosetting or thermoplastic matrix compatible with the matrix used for the composite structure 23.

In this case, the heating structure 30 introduced may thus be disposed in the inner face fi of the air inlet lip 2, or integrated in the thickness of the composite structure 23, such as FIGS. 4 and 5 more particularly illustrate.

It is worth noting that the thicknesses of the different layers of the leading edge 2, illustrated on FIGS. 2 to 5, are not necessarily scaled.

According to the variants of the leading edge 2, it is also provided or not, anti-erosion means which will be described further down.

The composite structure 23 and the anti-erosion means, if need be, form the outer skin of the leading edge 2.

In the frost-susceptible areas, this composite structure 23 is a structure formed of a reinforcing frame of fibers associated with a matrix which provides the cohesion of the structure and the retransmission of the forces towards the fibers.

Advantageously, this matrix is reinforced by at least one material of which the thermal conductivity at room temperature is greater than or equal to 800 W·m⁻¹·K⁻¹ in such a manner as to provide transverse thermal conductivity within the leading edge structure.

In addition, this reinforcement is inert from a chemical point of view with respect to the fibers constituting the layers of the composite structure 23, 23d.

Advantageously, it leads to no reaction with the components constituting the matrix, nor galvanic couple with the fibers of the frame of the structure 23.

Furthermore, in a variant, this material may also be a material which is not electrically conductive.

In a preferred but not limiting form, this material is a diamond powder.

A reinforcement in diamond material significantly increases the transverse thermal conductivity of the composite material.

However, in variants, this material may be nanoparticles or nanotubes, in particular but not exclusively of carbon material.

It may be in the form of powder or in any other form of material.

A particular form of the present disclosure is selected for the rest of the description, namely the form in which the matrix is reinforced by diamond powder.

According to the variant, the composite structure 23 may be a multi-axial, monolithic, self-stiffened or sandwich structure, configured to meet the constraints of thermal efficiency and structural hold of the leading edge structure 2.

By multi-axial, is meant a composite comprising fibers in the three directions, of space, of which reinforcing fibers crossing it in its thickness, allowing to connect the layers of composites together.

By “monolithic” is meant the different plies (that is to say the layers each comprising fibers laid in resin) forming the composite material are joined together, without interposition of a core between these plies.

By sandwich structure, is meant a composite structure composed of two monolithic skins separated by at least one light core able to be made, in a non-limiting example, by means of a honeycomb structure.

The composite structure 23 may thus be formed by a superimposition of unidirectional (UD) and/or multidimensional plies (2D in particular) and oriented to form a preform.

The thermal conductivity of the composite structure 23 is determined according to the volume rate of fibers 6 and the volume rate a of diamond powder doping the matrix.

Thus, it may be determined by the following formula (1):

λcomposite=β*λfiber+(1−β)*(α*λdiamond+(1−α)*λmatrix) (1)

With λ composite, λ fiber, λ diamond and λ matrix being defined as the respective heat conductivities of the composite structure 23, of the reinforcing fibers, of the diamond and the matrix (the most often of a plastic material of thermosetting or thermoplastic resin type)

In a first variant, the rate a of diamond powder doping the matrix of the composite structure 23 is located between 1 and 50%, and in one form 3 to 40%, and in another form 3 to 10%, thus in order to dope the composite structure and reach a global thermal conductivity with an order of magnitude equivalent to structural metallic alloys, while allowing the composite structure 23 to keep the structural properties linked to the matrix.

The advantage of this range is to propose a composite structure 23 of which the thermal conductivity is improved while keeping a macroscopically conventional matrix.

In one form, it is chosen a volume rate a equal to 30% and a volume rate of fibers β of 63%, by choosing the following conductivities: λ resin=0.5 W·m⁻¹·K⁻¹λ fiber=0.7 W·m⁻¹·K⁻¹ and λ diamond=1000 W·m⁻¹·K⁻¹

The thermal conductivity of the obtained composite structure 23 is, as a result, of 111.6 W·m⁻¹·K⁻¹

Hence this confers to the leading edge structure 2 a thermal conductivity comparable to that of certain metals (for example aluminum).

In a second variant, the rate a of diamond powder doping the matrix of the composite structure 23 is located between 50% to 90% and preferably 50 to 70%.

This offers the advantage of proposing a composite structure 23 of aggregate type of which the thermal conductivity is improved just like the hardness of the composite structure 23.

Hence, this composite structure 23 has an improved mechanical behavior in compression.

Furthermore, in one form, the thermal conductivity is defined in a progressive manner according to the profile of the leading edge structure 2, in order to master the thermal behavior of the composite structure 23.

Advantageously, the composite structure 23 is configured in such a manner that the matrix progresses and, more particularly, the doping thereof by the material of which the thermal conductivity at room temperature is greater than or equal to 800 W·m⁻¹·K⁻¹ like the diamond powder progresses in the thickness of the composite structure 23.

In a first variant, the doping of the matrix is higher in the outer plies 23b of the composite structure 23 that is to say the plies forming the outer face fe of the leading edge structure 2.

On FIG. 2, by way of illustration, these plies 23b are facing the heating structure 30.

The matrix comprises a rate of diamond powder greater than or equal to 60% in the outer plies 23b and a rate lower than 50% in the other plies of the structure 23.

In this configuration, the plies working in compression will be the most filled with diamond (with potentially an aggregate behavior) while those working in traction will remain with a more conventional matrix.

In a second non-exclusive variant of the first, the rate of reinforcing fibers may also vary in the thickness of the structure 23.

Thus, the rate of fibers may be more important in the outer plies 23b of the composite structure 23.

This higher rate of fiber combined with that of the rate of diamond powder lower than 50% in these same plies improves the behavior in traction of the composite structure 23 and of the leading edge structure 2.

In a third variant, some outer 23b and/or inner 23a plies are selectively doped in diamond powder in an appropriate manner in such a manner as to have a distribution of doping of the resin the fiber rate suitable for the mechanical constraints witnessed by the nacelle piece.

Furthermore, as regards the diamond powder, any isotope may be used.

Moreover, as regards the diamond powder granulometry, it may be selected diamond sizes lower than 10 μm, and in one form lower than 5 μm, and in another form grains lower than 3 μm.

It may also be chosen a very fine granulometry of diamond powder up to 0.1 μm, which is low compared to the diameters of the fiber filaments usually ranging between 4 and 10 μm.

The obtained mixture hence does not hinder the cohesion of the fibers within its matrix of the composite structure 23.

In a variant, the diamond powder introduced in the matrix may be constituted of grains having several distinct granulometries with the purpose of maximizing the filling rate of the obtained aggregate.

In forms according to the present disclosure, it may be selected a doping of diamond powder comprising at least 50% of diamond grains of a size greater than 1 μm and at least 30% of grains of a size lower than 1 μm, or even 30% of grains of a size lower than 0.5 μm.

In another non-exclusive variant of the aforementioned one, the composite structure 23 is configured in such a manner that the granulometry of the doping progresses in the thickness of the structure 23.

Thus a granulometry may be distributed in the outer plies 23b of the composite structure 23 than in the inner plies 23a, in order to give a diamond concentrate greater in the outer layers of the composite structure 23 more exposed to erosion.

Furthermore, in the same vein but in another form, a layer with a high rate a of diamond powder may also be added in the outer plies 23b, thus in order to increase the resistance of the leading edge structure 2 to erosion.

In addition, one is freed from any additional surface coating in order to meet these erosion constraints.

Obviously, it may be further provided, one or several other composite structures 23 in the leading edge structure 2.

Furthermore, in a second form illustrated on FIG. 5 of leading edge structure 2, a second composite structure 23d may be provided, this structure being interposed between the heating structure 30 and the thermally insulating material layer 20.

According to the selected variant, the fibers of the frame are carbon fibers, but it is also possible to use glass fibers or Kevlar® (Aramid) or any other type of fibers depending on the sought purpose.

Based on a certain level of conductivity of the matrix (resin) of the composite structure 23 obtained thanks to the present disclosure, the general conductivity of the composite structure 23 will be hardly modified by the thermal conductivity of the used fibers.

As regards the matrix, many matrices may be used like an organic matrix or other.

It may be formed in particular in thermosetting resin such as epoxy resin, bismaleimide, polyimide, phenolic, or thermoplastic PPS (Polyphenylene sulfide), PEEK (Polyether ether ketone), PEKK (Polyether ketone-ketone), etc.

Furthermore, the nature of the material constituting the matrix may be different according to the ply of the considered composite structure 23 and its position in the thickness of the structure 23 provided that the compatibility of the resins together is met.

Furthermore, if the electric heating elements 30 of the frost protection are encapsulated in an insulating envelope (silicone or other), the substance constituting this envelope may advantageously be also doped by a material of which the thermal conductivity is greater than or equal to 800 W·m⁻¹·K⁻¹ such as diamond powder, in order to increase its conductivity.

In a non-exclusive variant of the first, the adhesive material or materials used in the assembling of the lip 2 and, particularly, the adhesive material 33 used in assembling the composite structure 23 and the heating structure 30 may also be doped in a similar manner.

Thanks to the present disclosure, the heat conduction features of the diamond of the composite structure are used, combined to those of the heating core 30, in order to meet the requirements of the defrosting in particular electric and/or the anti-icing and reduce the difference in temperature between the inner fi and outer fe skins of the lip 2.

The diamond rate in the thickness of the composite structure 23 is defined in such a manner as to provide transverse thermal conductivity and is suitable for dissipating the energy of the heating core 30 through the thickness of the composite structure 23.

The thermal and mechanical properties of the leading edge structure 2 are significantly reinforced by the presence of diamond in a progressive manner in the thickness of the composite structure 23.

Thus, a progressive conductivity is provided in the thickness of the composite structure 23.

With such a leading edge structure 2, the necessary temperature is obtained for providing a defrosting and/or anti-icing without exceeding locally the glass transition temperature of the composite structure 23, while remaining compatible with the thicknesses necessary for the structural problematic of an air inlet lip 2.

All these advantages are, also, obtained with a doping by materials other than diamonds having a thermal conductivity greater than or equal to 800 W·m⁻¹·K⁻¹.

Making a leading edge structure 2 comprising one or several composite structures 23 such as aforementioned may be provided by various manufacturing methods.

Thus, in one form, it is provided a method of manufacturing the composite structure 23 in which it is injected, by an injection moulding method of RTM type (Resin Transfer Moulding), the mixture matrix-diamond powder, carried out beforehand, in a mold containing the fibrous frame.

In a variant, the manufacturing method is an infusion method of RFI type (Resin Film infusion) in which the mixture matrix-diamond powder is diffused in a fibrous preform under the pressure exerted by a flexible bladder in the transverse direction to the plane of the preform.

In another variant, the manufacturing method is a method of draping pre impregnated fibers in which the dry fibers are associated with the mixture matrix-diamond powder then the assembly is polymerized in a subsequent step under vacuum and or in an autoclave.

In another variant, it will be associated, a film of calendered matrix-powder having a more or less high rate of powder, for one or several layers and in particular, the outer surface layer 23b, the interface layer between the monolithic layer 23 and the heating element structure 31, and an assembly of pre-impregnated layers of fabric for making the composite structure 23.

In another variant, the surface layer 23b is a layer of thermoplastic matrix doped with diamond powder and the monolithic structure 23 is made according to a method of infusion or transfer of thermosetting resin.

Of course, the present disclosure is in no way limited to the aforementioned forms, and any other variants of structures in composite materials doped with diamond powder may be considered.

Particularly, it may be used with a frost protection principle other than electric as long as the operating temperature is compatible with the material used.

Furthermore, whatever the concentration of the doping, the curing of the composite materials is improved and potentially accelerated by increasing the thermal conductivity of their resin (more homogenous temperature in the material, more rapid diffusion).

It is also possible to use diamond powder with already conductive metallic matrices (for example titanium) of which the thermal conductivity is sought to be increased on condition that the melting temperatures and eutectic of these alloys as well as the melting mode (for example under vacuum) preserves the chemical and/or crystalline integrity of the diamond powder to be dissolved.

The present disclosure is further, not limited to the leading edge structures, in particular of aircraft air inlet lip but encompasses any element constituting an aircraft nacelle comprising at least one composite structure associated with a heating element.

What is claimed is:

1. An element constituting an aircraft nacelle formed of at least one composite structure and one heating element, the element comprising frost protection means, wherein the composite structure comprises a matrix reinforced by at least one material of which the thermal conductivity at room temperature is greater than or equal to 800 W·m⁻¹·K⁻¹ so as to provide a transverse thermal conductivity within the nacelle.

2. The element according to claim 1, wherein the composite structure comprises the matrix reinforced by at least a diamond powder so as to provide a transverse thermal conductivity within the nacelle.

3. The element according to claim 1, wherein the composite structure comprises the matrix reinforced by at least nanoparticles or nanotubes so as to provide a transverse thermal conductivity within the nacelle.

4. The element according to claim 1, wherein a rate a of material doping the matrix of the composite structure is located between 1% and 50%.

5. The element according to claim 1, wherein a rate a of material doping the matrix of the composite structure is located between 50% and 90%.

6. The element according to claim 1, wherein the composite structure is configured such that material doping of the matrix of the composite structure progresses in the thickness of the composite structure.

7. The element according to claim 6, wherein the material doping of the matrix of the composite structure is higher in outer plies of the composite structure forming an outer face of the element.

8. The element according to claim 6, wherein the matrix of some plies of the composite structure is selectively material doped

9. The element according to claim 1, wherein the composite structure is configured such that granulometry of the material doping the matrix of the composite structure progresses in the thickness of the composite structure.

10. The element according to claim 1, wherein the composite structure has a density of fibers variable in the thickness of the composite structure.

11. The element according to claim 1, further comprising an assembling material between the composite structure and the heating element, the assembling material being reinforced by at least one material of which the thermal conductivity at room temperature is greater than or equal to 800 W·m⁻¹·K⁻¹ in such a manner as to provide a transverse thermal conductivity within the nacelle.

12. The element according to claim 1, further comprising a heat insulator laid in the heating element or covered by the heating element or separated from the heating element by a structure of composite plies.

13. A leading edge structure for aircraft nacelle air inlet, comprising a leading edge and an internal wall defining a longitudinal compartment inside the leading edge structure housing at least one of defrosting and anti-icing means, the leading edge structure being formed of at least one composite structure and one heating element in which the leading edge structure is formed of the element according to claim 1.

14. The structure according to claim 13, wherein the composite structure forms an outer skin of the leading edge structure.

15. An air inlet comprising the leading edge structure in accordance with claim 13.
